(19) United States
(12) Patent Application Publication
(10) Pub. No.: US 2019/0084380 A1
(43) Pub. Date: Mar. 21, 2019

(54) DEFROSTER NOZZLE OF VEHICLE GENERATING VORTEX DURING DISCHARGING

(71) Applicants: HYUNDAI MOTOR COMPANY, Seoul (KR); KIA Motors Corporation, Seoul (KR); Research & Business Foundation SUNGKYUNKWAN UNIVERSITY, Gyeonggi-do (KR)

(72) Inventors: Hyuck-Yong Kwon, Gyeonggi-do (KR); Yung-Kyun Kim, Gyeonggi-do (KR); Bock-Cheol Lee, Gyeonggi-do (KR); Young-Il Kim, Seoul (KR); Do-Hyung Kim, Chungcheongnam-do (KR); Jin-Kee Lee, Gyeonggi-do (KR); Ryun-Geun Song, Gangwon-do (KR)

(73) Assignees: HYUNDAI MOTOR COMPANY, Seoul (KR); KIA Motors Corporation, Seoul (KR); Research & Business Foundation SUNGKYUNKWAN UNIVERSITY, Gyeonggi-do (KR)

(21) Appl. No.: 15/869,030

(22) Filed: Jan. 12, 2018

(30) Foreign Application Priority Data
Sep. 21, 2017 (KR) 10-2017-0121922

(51) Int. Cl. B60H 1/34; B60H 1/24; B60S 1/54; B60S 1/02

(52) U.S. Cl. CPC B60H 1/3457; B60H 1/3407; B60S 1/023; B60S 1/54; B60H 1/242

(57) ABSTRACT

A defroster nozzle of a vehicle installed below a windshield of the vehicle and discharging conditioned air toward the windshield, the defroster nozzle generating vortex during discharging is disclosed. The defroster nozzle may include a housing formed in a cylindrical shape and having an inlet formed at one end of the housing through which the conditioned air is introduced, and an outlet formed adjacent to the windshield through which the air is discharged, and a vortex generator configured to protrude from an inner side surface of the housing to discharge the air introduced into the housing as vortex in the inner side surface of the housing.

### CROSS-REFERENCE TO RELATED APPLICATIONS

This application claims priority to Korean Patent Application No. 10-2017-0121922, filed on Sep. 21, 2017, which is incorporated herein by reference in its entirety.

### BACKGROUND

### Field

Exemplary embodiments of the present disclosure relate to a defroster nozzle that supplies wind to a windshield of a vehicle to prevent dewdrops or water drops from being formed on the windshield, and more particularly, to a defroster nozzle of a vehicle generating vortex during discharging, in which vortex is generated during discharging to improve moisture removal performance.

### Description of Related Art

In a vehicle, an air-conditioning apparatus for maintaining comfortability of a passenger riding in the vehicle is provided.

Further, even in a case in which fine waterdrops are formed on a windshield of the vehicle due to humidity of an interior of the vehicle and temperature difference between the interior of the vehicle and the outside of the vehicle to obstruct a view, dry air is blown from the air-conditioning apparatus to the windshield to remove moisture on the windshield.

To this end, as illustrated in FIG. 1, a defroster nozzle 110 discharging conditioned air is installed below a windshield 1, and when an air-conditioning mode is changed by an operation of a passenger, the conditioned air is sprayed from the defroster nozzle 110 to the windshield 1.

Referring now to FIGS. 2 and 3, in the defroster nozzle 110 having the above-described configuration according to the related art, a housing 111 and an air guide 112 controlling a direction of air discharged from the defroster nozzle 110 and formed in the housing 111 are formed, such that only a direction of air discharged from the defroster nozzle 110 may be controlled. A grille (not illustrated) for preventing foreign material from being inserted into the housing 111 is formed at an outlet side of the housing 111.

The defroster nozzle 110 according to the related art may control a direction of discharged air, but flow of the air is simple, such that an area distant from a discharge port may not be rapidly dehumidified.

As illustrated in FIG. 4, wind discharged from the defroster nozzle 110 shows flow like steady flow, thus air flowing along the windshield 1 are not mixed to each other. Accordingly, if wet air flows adjacent to the windshield 1, waterdrops formed on a surface of the windshield 1 may not be easily removed.

Further, as illustrated in FIG. 5, since a speed of the flow is not high but is relatively constant, dehumidification at a portion distant from the defroster nozzle 110 is not smoothly performed.

### SUMMARY

An embodiment of the present disclosure is directed to a defroster nozzle of a vehicle generating vortex during discharging, in which a vortex characteristic is applied to conditioned air that is discharged from an outlet, thereby rapidly removing waterdrops formed on a windshield.

Other objects and advantages of the present disclosure can be understood by the following description, and become apparent with reference to the embodiments. Also, it is obvious to those skilled in the art to which the present disclosure pertains that the objects and advantages of the present disclosure can be realized by the means as claimed and combinations thereof.

In accordance with an embodiment, a defroster nozzle of a vehicle installed below a windshield of the vehicle and discharging conditioned air toward the windshield is disclosed. The defroster nozzle generates vortex during discharging and includes a housing having a cylindrical shape and having an inlet formed at one end of the housing through which the conditioned air is introduced, and an outlet formed adjacent to the windshield through which the air is discharged. The defroster nozzle further includes a vortex generator configured to protrude from an inner side surface of the housing to discharge the air introduced into the housing as vortex in the inner side surface of the housing.

The vortex generator may have a height increased along a flow direction of the air.

A cross section of the vortex generator taken along a flow direction of the air may have a triangle shape so that a height of the vortex generator is increased along the flow direction of the air.

The vortex generator may be inclined with respect to flow of the flowing air at a predetermined angle.

The vortex generator may be inclined with respect to the flow direction of the air at an angle of 25 to 30 degrees.

The faster the flow velocity of the air is, the smaller the maximum height of the vortex generator may be.

The housing may have a width larger than a height thereof, and the vortex generator may be formed on an inner side surface adjacent to the windshield.

The vortex generator and a vortex generator adjacent thereto may be inclined with respect to the flow direction of the air in directions different from each other.

The vortex generator may be formed so that a portion of the vortex generator having a small height is closer to the vortex generator adjacent thereto, as compared to a portion of the vortex generator having a large height.

Two vortex generators adjacent to each other may be arranged in a “V” shape.

The vortex generator may be spaced apart from the outlet of the housing by a predetermined distance.

The vortex generator and a vortex generator adjacent thereto may be spaced apart from the outlet of the housing by the same distance.

### BRIEF DESCRIPTION OF THE DRAWINGS

Exemplary aspects are illustrated in the drawings. It is intended that the embodiments and figures disclosed herein are to be considered illustrative rather than restrictive.

FIG. 1 is a perspective view illustrating a state in which a defroster nozzle of a vehicle according to the related art is installed in an interior of the vehicle.

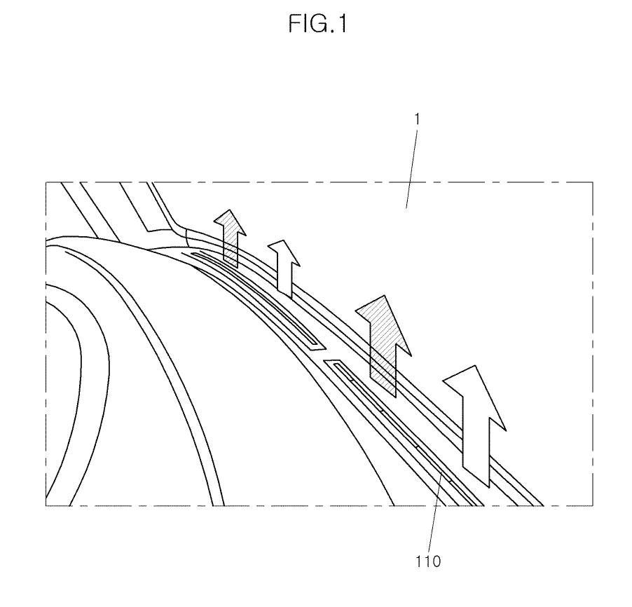

FIG. 2 is a perspective view illustrating an example of the defroster nozzle of a vehicle according to the related art.

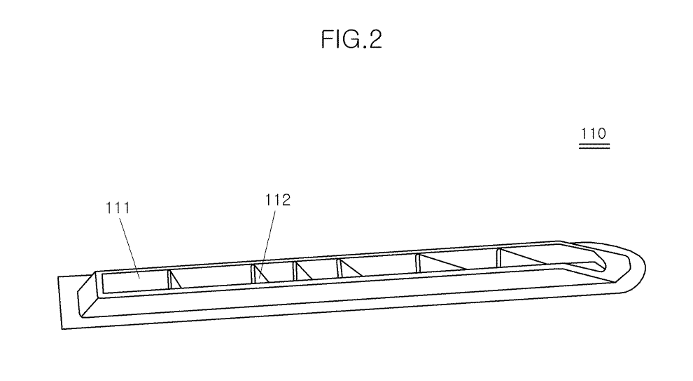

FIG. 3 is a partial cut-away perspective view of the defroster nozzle of a vehicle of FIG. 2.

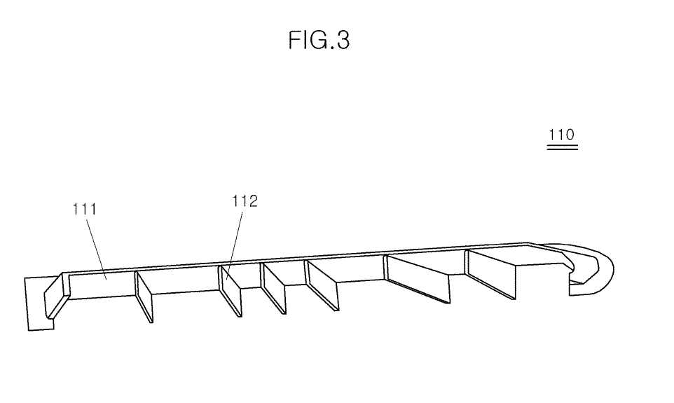

FIG. 4 is a view illustrating air flow in a state in which the defroster of a vehicle according to the related art is installed.

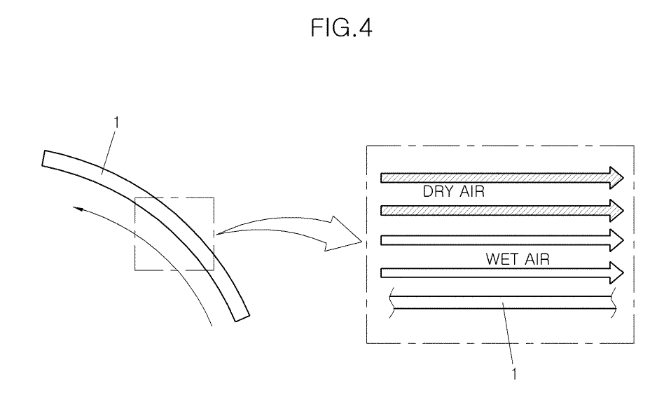

FIG. 5 is a graph illustrating air flow by the defroster of a vehicle according to the related art.

FIG. 6 is a cross-sectional view illustrating a defroster nozzle of a vehicle generating vortex during discharging according to an embodiment of the present disclosure.

FIG. 7 is a perspective view illustrating a vortex generator in the defroster nozzle of a vehicle generating vortex during discharging according to an embodiment of the present disclosure.

FIG. 8 is a plan view illustrating the vortex generator in the defroster nozzle of a vehicle generating vortex during discharging according to the present disclosure.

FIG. 9 is a rear perspective view illustrating the defroster nozzle of a vehicle generating vortex during discharging according to the present disclosure.

FIG. 10 is a schematic view illustrating air flow by the defroster nozzle of a vehicle generating vortex during discharging according to the present disclosure.

FIG. 11 is a graph illustrating air flow by the defroster nozzle of a vehicle generating vortex during discharging according to the present disclosure.

FIG. 12 is a perspective view illustrating a state in which vortex generators adjacent to each other are formed in opposite directions from each other in the defroster nozzle of a vehicle generating vortex during discharging according to the present disclosure.

FIG. 13 is a perspective view illustrating a state in which vortex generators adjacent to each other are formed to be parallel to each other in the defroster nozzle of a vehicle generating vortex during discharging according to the present disclosure.

### DETAILED DESCRIPTION

Hereinafter, a defroster nozzle of a vehicle generating vortex during discharging according to the present disclosure will be described in detail with reference to the accompanying drawings.

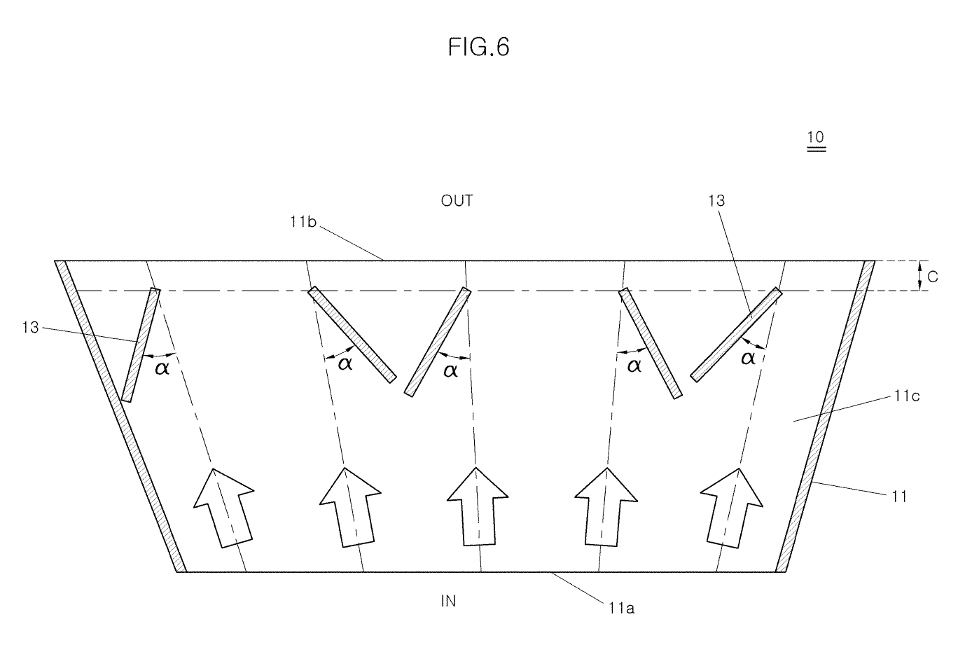

Referring to FIG. 6, a defroster nozzle 10 of a vehicle generating vortex during discharging according to the present disclosure includes a housing 11 formed in a cylindrical shape. The housing 11 includes an inlet 11a formed at one end of the housing through which conditioned air is introduced, and an outlet 1lb formed adjacent to a windshield 1 through which the air is discharged. The defroster nozzle 10 further includes a vortex generator 13 protruding from an inner side surface 11c of the housing 11 to discharge the air introduced into the housing 11 as vortex in the inner side surface of the housing 11.

The housing 11 is formed in a cylindrical shape. The housing 11 is installed below the windshield 1 to blow conditioned air toward the windshield 1, thus has a small height and a large width.

One side of the housing 11 is the inlet through which the conditioned air is introduced from an air-conditioning apparatus, and the other side of the housing 11 is the outlet through which the air is discharged toward the windshield 1. In the inlet side, an air guide (not illustrated) controlling a direction of conditioned air introduced into the housing 11 is installed.

The vortex generator 13 is formed on the inner side surface of the housing 11, and generates vortex while air flows in the housing 11. In a state in which the flow direction of the air is determined by the air guide, vortex is applied to the air flow by the vortex generator 13.

The vortex generator 13 protrudes from a surface of the housing 11. The vortex generator 13 is formed in a plate shape, and generates vortex while air passes through the vortex generator 13.

The vortex generator 13 has a height which is increased along a flow direction of the air.

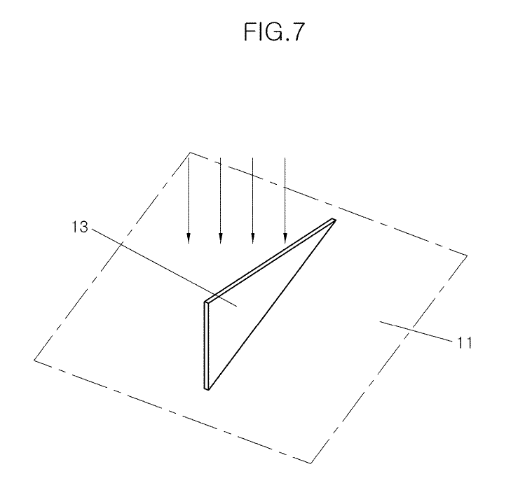

Accordingly, a cross section of the vortex generator 13 taken along the flow direction of the air may have a triangle shape, and a height of the vortex generator 13 at a side where the air is discharged is larger than that at a side where the air is introduced. That is, referring to FIG. 7, it may be appreciated that a height at an upper portion (inlet side) is small, and the height is increased toward a lower portion (outlet side).

A maximum height of the vortex generator 13 may be the same as a thickness of a boundary layer measured by particle image velocimetry (PIV). The PIV is one of methods for measuring velocity of fluid, a thickness of the boundary layer is obtained by the PIV, and a maximum height of the vortex generator 13 is obtained accordingly. For example, if air is discharged from a blower at 0.8 W, the thickness of the boundary layer measured by the PIV is 5.7 mm, which becomes the maximum height of the vortex generator 13. If the air is discharged at 2.6 W, the thickness of the boundary layer is 4.97 mm, and the maximum height of the vortex generator 13 is 4.97 mm. Accordingly, as velocity of air flowing in the defroster nozzle 10 is increased, the maximum height of the vortex 13 is decreased.

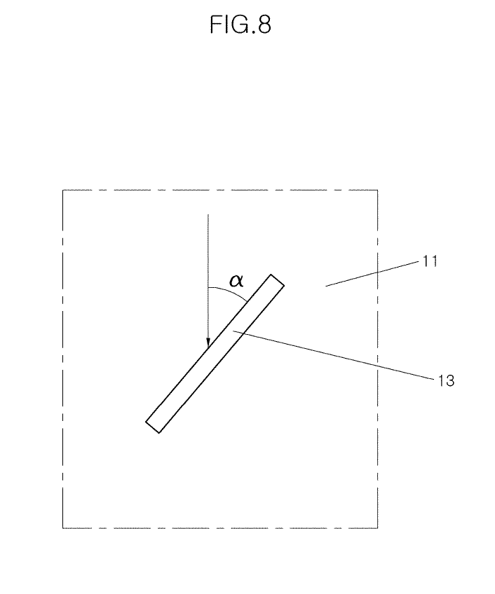

Further, it is preferable that the vortex generator 13 is inclined with respect to the air flow at a predetermined angle. FIGS. 6 and 8 are a cross-sectional view and a front view of the vortex generator 13 formed on the inner side surface of the housing 11. The vortex generator 13 is inclined with respect to the flowing air at a predetermined angle (α).

For example, it is preferable that the vortex generator 13 is inclined with respect to the flowing air at an angle (angle of attack) of 25 to 30 degrees. In particular, more preferably, the angle of attack is 30 degrees.

When the angle of attack is 30 degrees, mixing of fluid in a vertical direction is most active and a distance at which the air flow is effective (survival distance) is largest. If the angle of attack is larger than 30 degrees such as 45 degrees and 60 degrees, a mixing rate and a survival distance of the fluid are decreased.

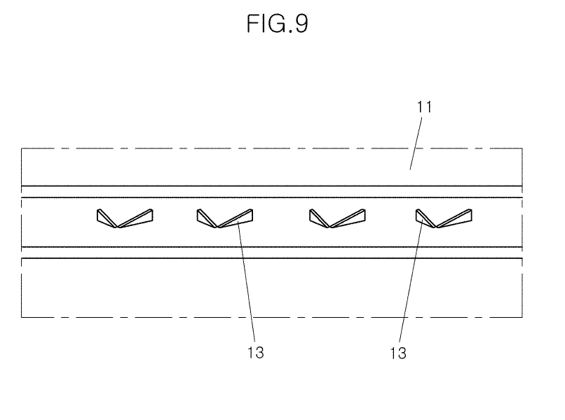

Further, it is preferable that the vortex generator 13 is formed on the inner side surface adjacent to the windshield 1 in the housing 11. As described above, the housing 11 has a small height (vertical direction in FIG. 9), and a large width (horizontal direction in FIG. 9), and the vortex generator 13 is formed on the inner side surface adjacent to the windshield 1. That is, in FIG. 9, the lower portion is adjacent to the windshield 1.

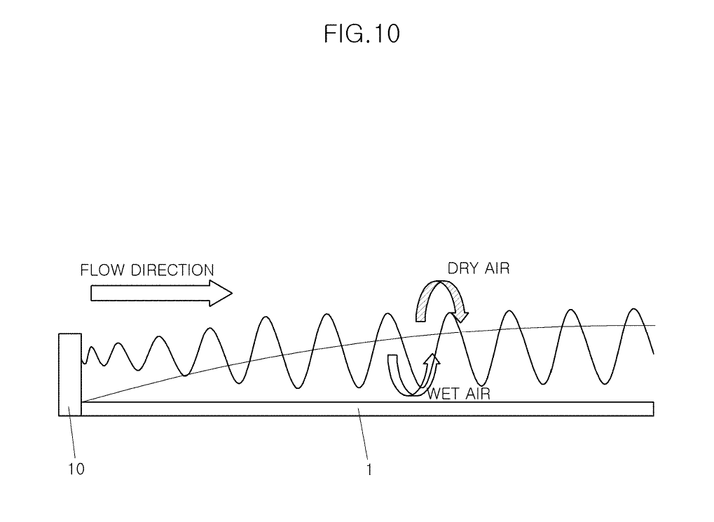

As the vortex generator 13 is formed, as illustrated in FIG. 10, rotation and vortex are generated in flow of air discharged from the defroster nozzle 10 to promote mixing between dry air and wet air, such that it is possible to easily remove waterdrops or moisture formed on the windshield 1. That is, when dry air is discharged from the defroster nozzle 10, air flowing to a portion adjacent to the windshield becomes wet, and air flowing to a portion distant from the windshield 1 flows in an initially discharged state (dry state). Here, the vortex generator 13 generates rotation and vortex in the air flowing on the windshield 1 to promote mixing between dry air and wet air, such that it is possible to rapidly remove moisture on the windshield 1.

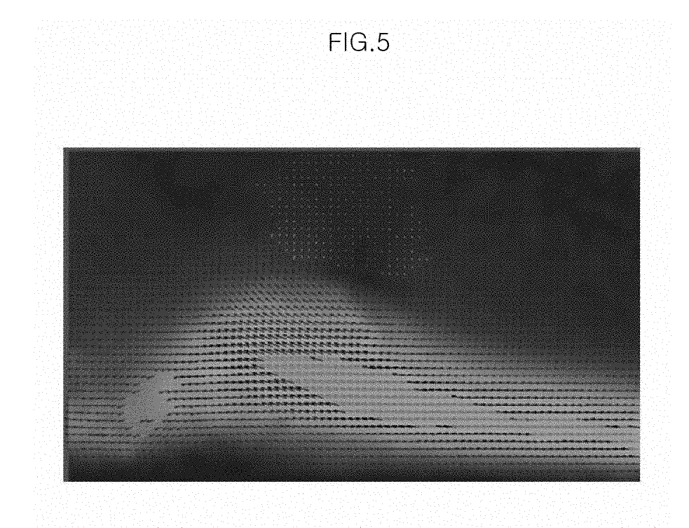

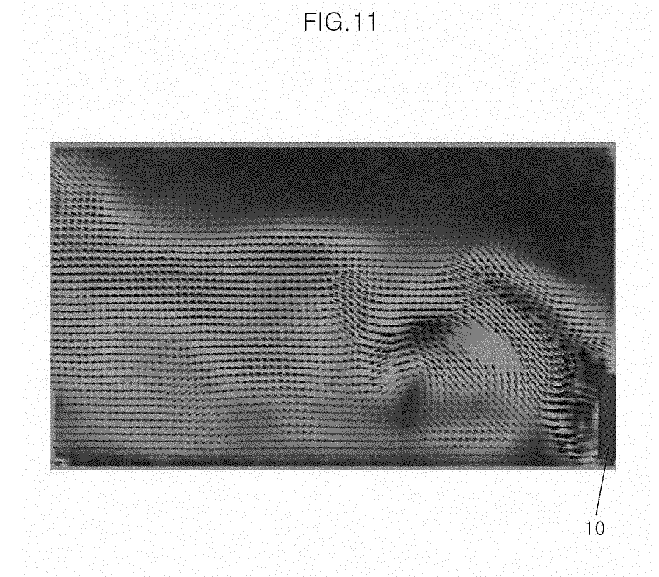

Further, as illustrated in FIG. 11, flow velocity distribution of flow of air flowing in the defroster nozzle 10 is widened, and in particular, it may be appreciated that flow velocity at a surface on which the vortex generator 13 is high. Further, it may be appreciated that flow velocity in the vicinity of a bottom surface is also increased as compared to the related art (see FIG. 5).

Meanwhile, the vortex generator 13 is formed in plural on the inner side surface of the housing 11.

If a plurality of vortex generators 13 are formed in the housing 11, the vortex generators 13 are spaced apart from the outlet of the housing 11 by a predetermined distance. That is, as illustrated in FIG. 6, all the vortex generators 13 are formed to be spaced apart from the outlet by a predetermined distance c.

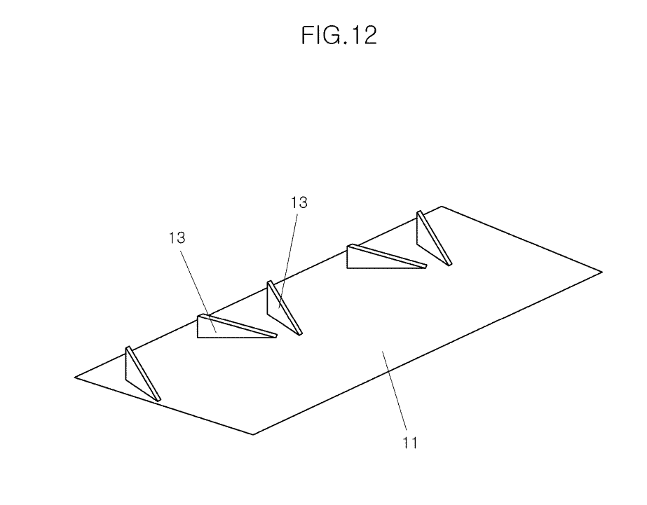

At this time, in FIG. 12, the vortex generator 13 is formed in an opposite direction to a vortex generator 13 adjacent thereto. It is preferable that vortex generators 13 adjacent to each other are formed in different directions from each other.

Further, the vortex generator 13 is formed so that a portion of the vortex generator 13 having a small height is closer to an adjacent vortex generator 13, as compared to a portion of the vortex generator 13 having a large height. Referring to FIGS. 6, 9, and 12, two vortex generators 13 are formed in a “V” shape, and portions having a small height are adjacent to each other.

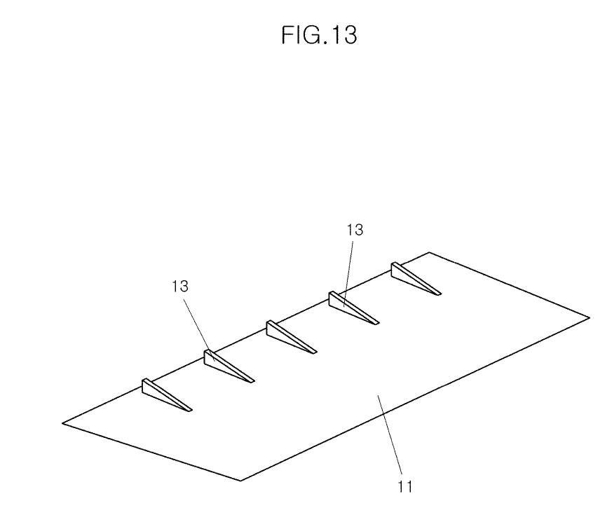

However, at a portion in which it is structurally difficult to form vortex generators 13 adjacent to each other in opposite directions, the vortex generators adjacent to each other may be formed to be parallel to each other, as shown in FIG. 13. A plurality of defroster nozzles 10 are installed below the windshield 1, and in some defroster nozzles 10, it may be difficult to form vortex generators 13 adjacent to each other in opposite directions. In this case, the vortex generators 13 adjacent to each other are formed to be parallel to each other.

In the defroster nozzle of a vehicle generating vortex during discharging having the above configuration according to the present disclosure, as conditioned air passes through the vortex generator, vortex is formed, such that flow velocity distribution of the conditioned air is widened, and the moving distance of the conditioned air is increased. As a result, moisture of a portion of the windshield distant from the discharging port may also be rapidly removed.

While a number of exemplary aspects have been discussed above, those of skill in the art will recognize that still further modifications, permutations, additions and sub-combinations thereof of the disclosed features are still possible. It is therefore intended that the following appended claims and claims hereafter introduced are interpreted to include all such modifications, permutations, additions and sub-combinations as are within their true spirit and scope.

What is claimed is:

1. A defroster nozzle of a vehicle installed below a windshield of the vehicle and discharging conditioned air toward the windshield, the defroster nozzle generating vortex during discharging, comprising:
a housing having a cylindrical shape and having an inlet formed at one end of the housing through which the conditioned air is introduced, and an outlet formed adjacent to the windshield through which the air is discharged; and
a vortex generator configured to protrude from an inner side surface of the housing to discharge the air introduced into the housing as vortex in the inner side surface of the housing.

2. The defroster nozzle of claim 1, wherein the vortex generator has a height increased along a flow direction of the air.

3. The defroster nozzle of claim 1, wherein a cross section of the vortex generator taken along a flow direction of the air has a triangle shape so that a height of the vortex generator is increased along the flow direction of the air.

4. The defroster nozzle of claim 2, wherein the vortex generator is inclined with respect to flow of the flowing air at a predetermined angle.

5. The defroster nozzle of claim 4, wherein the vortex generator is inclined with respect to the flow direction of the air at an angle of 25 to 30 degrees.

6. The defroster nozzle of claim 2, wherein the faster the flow velocity of the air is, the smaller the maximum height of the vortex generator is.

7. The defroster nozzle of claim 2, wherein the housing has a width larger than a height thereof, and the vortex generator is formed on an inner side surface adjacent to the windshield.

8. The defroster nozzle of claim 2, wherein the vortex generator and a vortex generator adjacent thereto are inclined with respect to the flow direction of the air in directions different from each other.

9. The defroster nozzle of claim 8, wherein the vortex generator is formed so that a portion of the vortex generator having a small height is closer to the vortex generator adjacent thereto, as compared to a portion of the vortex generator having a large height.

10. The defroster nozzle of claim 9, wherein two vortex generators adjacent to each other are arranged in a “V” shape.

11. The defroster nozzle of claim 2, wherein the vortex generator is spaced apart from the outlet of the housing by a predetermined distance.

12. The defroster nozzle of claim 11, wherein the vortex generator and a vortex generator adjacent thereto are spaced apart from the outlet of the housing by the same distance.
